(19) United States
(12) Patent Application Publication
(10) Pub. No.: US 2022/0026760 A9
(43) Pub. Date: Jan. 27, 2022

(54) DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: Hongming ZHAN, Beijing (CN); Xibin SHAO, Beijing (CN); Ruichen ZHANG, Beijing (CN); Dongchuan CHEN, Beijing (CN); Kaixuan WANG, Beijing (CN)

(21) Appl. No.: 16/640,665

(22) PCT Filed: Aug. 9, 2019
(86) PCT No.: PCT/CN2019/100056

§ 371 Date: Feb. 20, 2020

(30) Foreign Application Priority Data
Aug. 29, 2018 (CN) 20180994913.8

(51) Int. Cl. G02F 1/1335; G02F 1/1347; G02F 1/1345

(52) U.S. Cl. CPC G02F 1/133504; G02F 1/133562; G02F 1/1345; G02F 1/133531; G02F 1/1347; G02F 1/133567

(57) ABSTRACT

The present disclosure relates to a display device. The display device includes a first liquid crystal cell and a second liquid crystal cell disposed opposite to each other, a first polarizer located on a side of the first liquid crystal cell away from the second liquid crystal cell, a second polarizer located on a side of the second liquid crystal cell away from the first liquid crystal cell, and a third polarizer located between the first liquid crystal cell and the second liquid crystal cell, wherein the display device further includes a polarization maintaining diffusion sheet located between the first liquid crystal cell and the second liquid crystal cell.

### CROSS REFERENCE TO RELATED APPLICATIONS

This patent application is a National Stage Entry of PCT/CN2019/100056 filed on Aug. 9, 2019, which claims the benefit and priority of Chinese Patent Application No. 201810994913.8 filed on Aug. 29, 2018, the disclosures of which are incorporated by reference herein in their entirety as part of the present application.

### BACKGROUND

Embodiments of the present disclosure relate to a field of displaying technology, in particular, to a display device.

The liquid crystal display device modulates the light emitted from the backlight source through a liquid crystal light valve to realize grayscale display. However, due to the influence of liquid crystal alignment, liquid crystal materials, and other materials on light scattering, it is difficult for liquid crystal display devices to achieve high contrast ratio.

### BRIEF DESCRIPTION

Embodiments of the present disclosure provide a display device.

One aspect of the present disclosure provides a display device. The display device includes a first liquid crystal cell and a second liquid crystal cell disposed opposite to each other, a first polarizer located on a side of the first liquid crystal cell away from the second liquid crystal cell, a second polarizer located on a side of the second liquid crystal cell away from the first liquid crystal cell, and a third polarizer located between the first liquid crystal cell and the second liquid crystal cell, wherein the display device further includes a polarization maintaining diffusion sheet located between the first liquid crystal cell and the second liquid crystal cell.

In an embodiment of the present disclosure, the polarization maintaining diffusion sheet is located between the third polarizer and the second liquid crystal cell or located between the first liquid crystal cell and the third polarizer.

In an embodiment of the present disclosure, the display device further includes a fourth polarizer located between the first liquid crystal cell and the second liquid crystal cell, wherein a direction of a transmission axis of the fourth polarizer is the same as a direction of a transmission axis of the third polarizer.

In an embodiment of the present disclosure, the polarization maintaining diffusion sheet is located between the third polarizer and the fourth polarizer.

In an embodiment of the present disclosure, the polarization maintaining diffusion sheet includes a directional diffusion film.

In an embodiment of the present disclosure, the directional diffusion film includes a first medium and a second columnar medium embedded in the first medium, and wherein the refractive index of the second columnar medium is different from that of the first medium.

In an embodiment of the present disclosure, a degree of polarization of the polarization maintaining diffusion sheet is greater than or equal to 95%.

In an embodiment of the present disclosure, the first liquid crystal cell includes a first wiring and a second wiring intersecting the first wiring, and the second liquid crystal cell includes a third wiring and a fourth wiring intersecting the third wiring, and wherein any one of the first wiring and the second wiring is not parallel to any one of the third wiring and the fourth wiring.

In an embodiment of the present disclosure, a shape of the first wiring and the second wiring is of a curved shape, and a shape of the third wiring and the fourth wiring is of a linear shape.

In an embodiment of the present disclosure, the first liquid crystal cell is located on a light incident side, and a distance between the adjacent first wirings or between the adjacent second wirings is greater than or equal to a distance between the adjacent third wirings or between the adjacent fourth wirings.

In an embodiment of the present disclosure, one of the first wiring and the second wiring is a data line, and the other of the first wiring and the second wiring is a scan line, and wherein one of the third wiring and the fourth wiring is a data line, and the other of the third wiring and the fourth wiring is a scan line.

In an embodiment of the present disclosure, a direction of a transmission axis of the first polarizer is parallel to a direction of a transmission axis of the second polarizer.

In an embodiment of the present disclosure, a direction of a transmission axis of the third polarizer is perpendicular to a direction of a transmission axis of the first polarizer and a direction of a transmission axis of the second polarizer.

In an embodiment of the present disclosure, the display device further includes a backlight source located on a side of the first liquid crystal cell away from the second liquid crystal cell.

In an embodiment of the present disclosure, the first liquid crystal cell is configured to perform dynamic region modulation on incident light from the backlight source, and wherein the second liquid crystal cell is configured to implement a display function.

Adaptive and further aspects and scope will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present application.

FIG. 1 is a schematic cross-sectional view of a display device;

FIG. 2 is a schematic cross-sectional view of a display device according to an embodiment of the present disclosure;

FIG. 3 is a schematic cross-sectional view of a liquid crystal cell according to an embodiment of the present disclosure;

FIG. 4 is a schematic cross-sectional view of a display device according to an embodiment of the present disclosure;

FIG. 5 is a schematic cross-sectional view of a display device according to an embodiment of the present disclosure;

FIG. 6 is a schematic cross-sectional view of a directional diffusion film according to an embodiment of the present disclosure;

FIGS. 7A-7C are schematic diagrams of a process of forming a directional diffusion film according to an embodiment of the present disclosure; and

FIG. 8 is a schematic plan view of wirings in a first liquid crystal cell and a second liquid crystal cell according to an embodiment of the present disclosure.

Corresponding reference numerals indicate corresponding parts or features throughout the several views of the drawings.

### DETAILED DESCRIPTION

As used herein and in the appended claims, the singular form of a word includes the plural, and vice versa, unless the context clearly dictates otherwise. Thus, the references “a”, “an”, and “the” are generally inclusive of the plurals of the respective terms. Similarly, the words “comprise”, “comprises”, and “comprising” are to be interpreted inclusively rather than exclusively. Likewise, the terms “include”, “including” and “or” should all be construed to be inclusive, unless such a construction is clearly prohibited from the context. The term “example” used herein, particularly when followed by a listing of terms, is merely exemplary and illustrative and should not be deemed to be exclusive or comprehensive.

Additionally, further to be noted, when the elements and the embodiments thereof of the present application are introduced, the articles “a/an”, “one”, “the” and “said” are intended to represent the existence of one or more elements. Unless otherwise specified, “a plurality of” means two or more. The expressions “comprise”, “include”, “contain” and “have” are intended as inclusive and mean that there may be other elements besides those listed. The terms such as “first” and “second” are used herein only for purposes of description and are not intended to indicate or imply relative importance and the order of formation.

The flow diagrams depicted herein are just one example. There may be many variations to this diagram or the steps (or operations) described therein without departing from the spirit of the disclosure. For instance, the steps may be performed in a differing order or steps may be added, deleted, or modified. All of these variations are considered a part of the claimed disclosure.

Exemplary embodiments will now be described more fully with reference to the accompanying drawings.

In order to solve the problem that it is difficult for a liquid crystal display device to achieve high contrast ratio, one method is to employ partitioning control of the backlight source to dynamically adjusting the light intensity of the backlight source locally according to the requirements of the local grayscale of the display screen, so as to achieve high dynamic contrast ratio.

Generally, such a dynamically adjustable backlight source has two configurations, i.e., one-dimensional configuration and two-dimensional configuration. For example, edge-type backlights are partitioned along a row or column direction to achieve one-dimensional dynamic control. Due to this method can only achieve one dynamic modulation grayscale in the same row or column, the dynamic contrast ratio is not ideal. On the other hand, direct-type backlights can achieve two-dimensional dynamic backlight modulation through LEDs arranged in a matrix to obtain better dynamic contrast ratio. However, for the direct-type backlight, in order to prevent mura of the lamp, a certain light mixing distance from the LED to the display panel need to be ensured, which results in a larger thickness of the backlight source and thus the difficulty to achieve thinning. In general, the thickness of direct-type backlight modules used in large-sized TVs is more than 25 mm.

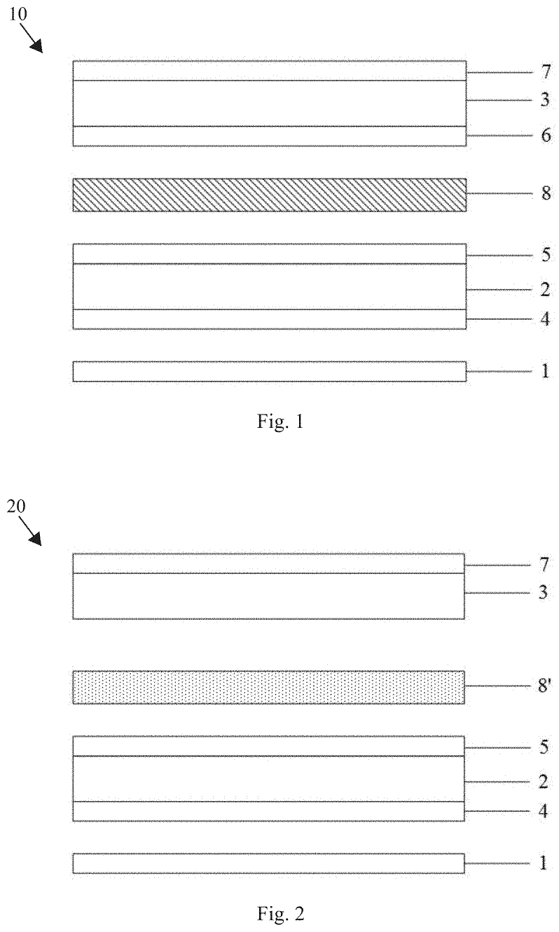

In order to ensure that the module is thin and better high dynamic contrast ratio can be obtained, a structure of two liquid crystal cells can be adopted. FIG. 1 is a schematic cross-sectional view of a display device. As shown in FIG. 1, in the display device 10, the first liquid crystal cell 2 performs dynamic region modulation on light incident from the backlight source 1, and the second liquid crystal cell 3 implements normal image display, thereby achieving high contrast ratio. Therefore, since liquid crystal pixels are used for light modulation, dynamic local light control at the pixel level can be achieved, and better dynamic contrast ratio can be obtained. However, in the structure of two liquid crystal cells of FIG. 1, due to the influence of liquid crystal light effect of the first liquid crystal cell 2 and the two polarizers 5 and 6, the light transmittance is greatly reduced, resulting in large increase in cost of backlight source and power consumption. In addition, in order to eliminate the Moire fringes generated after the two liquid crystal cells are superimposed, a diffusion sheet 8 needs to be added between the two layer liquid crystal cells. However, due to the influence of the diffusion sheet 8 itself on the transmitted light and the polarization state of the polarized light, the utilization efficiency of the light emitted from the first liquid crystal cell 2 by the second liquid crystal cell 3 is reduced, resulting in a further reduction in light efficiency of the overall device.

In order to solve the problem that the light efficiency of the overall device is greatly reduced when a diffusion sheet is disposed between two liquid crystal cells, embodiments of the present disclosure provide a display device capable of eliminating Moire fringes and improving light efficiency.

FIG. 2 is a schematic cross-sectional view of a display device according to an embodiment of the present disclosure. As shown in FIG. 2, the display device 20 includes a first liquid crystal cell 2 and a second liquid crystal cell 3 disposed opposite to each other, a first polarizer 4 located on a side of the first liquid crystal cell 2 away from the second liquid crystal cell 3, a second polarizer 7 on a side of the second liquid crystal cell 3 away from the first liquid crystal cell 2, and a third polarizer 5 located between the first liquid crystal cell 2 and the second liquid crystal cell 3. The display device 20 further includes a polarization maintaining diffusion sheet 8′ located between the first liquid crystal cell 2 and the second liquid crystal cell 3.

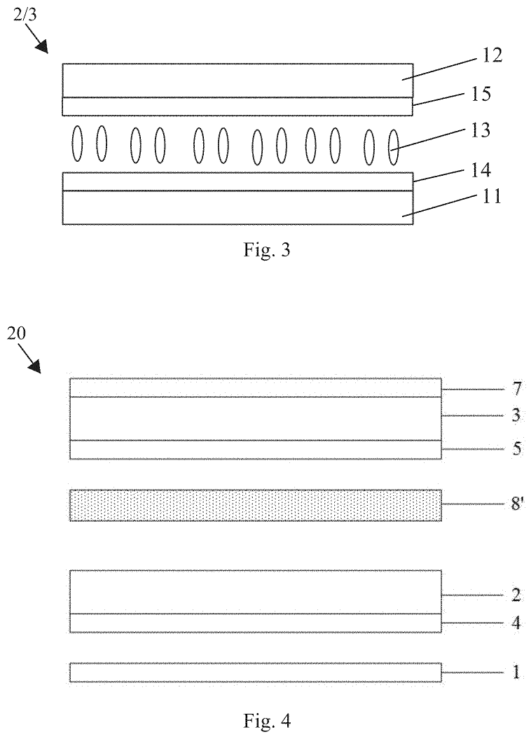

In an embodiment of the present disclosure, the first liquid crystal cell 2 or the second liquid crystal cell 3 may include, for example, two substrates disposed opposite to each other and a liquid crystal layer located between the two substrates. In addition, electrodes for deflecting the liquid crystal may be provided on the two substrates. An exemplary structure is shown, for example, in FIG. 3. In FIG. 3, the first liquid crystal cell 2 or the second liquid crystal cell 3 may include a first substrate 11 and a second substrate 12 disposed opposite to each other, a liquid crystal layer 13 located between the first substrate 11 and the second substrate 12, and a first electrode 14 located between the liquid crystal layer 13 and the first substrate 11 and a second electrode 15 located between the liquid crystal layer 13 and the second substrate 12.

In an embodiment of the present disclosure, the polarization maintaining diffusion sheet won't affect the polarization state of the light incident on the polarization maintaining diffusion sheet while eliminating the moire fringes, thereby being helpful for improving the light efficiency of the display device.

In FIG. 2, a polarization maintaining diffusion sheet 8′ is located between the third polarizer 5 and the second liquid crystal cell 3. It should be noted that, in this case, the polarization maintaining diffusion sheet 8′ may be in direct contact with the second liquid crystal cell 3, or may be spaced apart from the second liquid crystal cell 3 according to the needs of optical or module design. Optionally, as shown in FIG. 4, the polarization maintaining diffusion sheet 8′ may also be located between the first liquid crystal cell 2 and the third polarizer 5. It should be noted that, in this case, the polarization maintaining diffusion sheet 8′ may be in direct contact with the first liquid crystal cell 2 or may be spaced apart from the first liquid crystal cell 2 according to the needs of optical or module design.

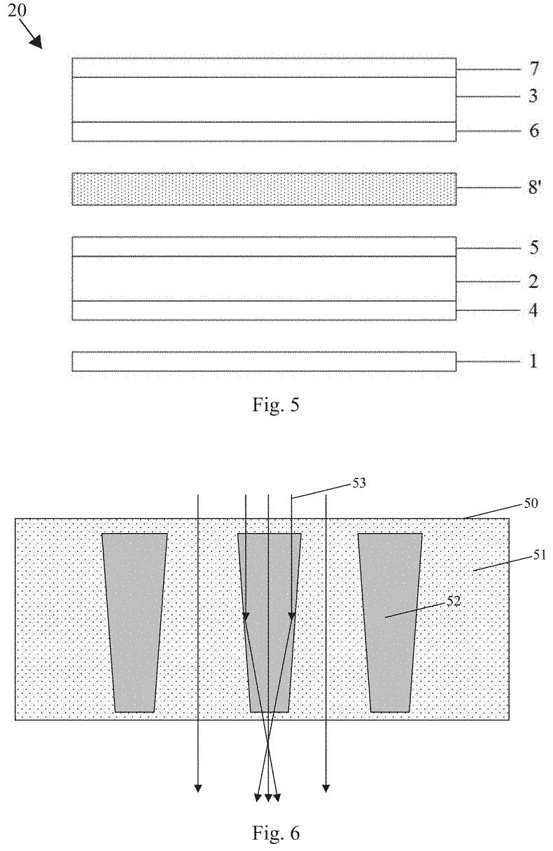

In an embodiment of the present disclosure, as shown in FIG. 5, the display device 20 further includes a fourth polarizer 6 located between the first liquid crystal cell 2 and the second liquid crystal cell 3. A direction of a transmission axis of the fourth polarizer 6 is the same as a direction of a transmission axis of the third polarizer 5. It should be noted that the positions of the third polarizer 5 and the fourth polarizer 6 shown in FIG. 5 are merely exemplary, and should not be regarded as a limit to the present disclosure. It can be understood that the positions of the third polarizer 5 and the fourth polarizer 6 can be exchanged with each other.

In FIG. 5, the polarization maintaining diffusion sheet 8′ may be located between the third polarizer 5 and the fourth polarizer 6.

In an embodiment of the present disclosure, the polarization maintaining diffusion sheet 8′ may include a directional diffusion film.

FIG. 6 is a schematic cross-sectional view of a directional diffusion film according to an embodiment of the present disclosure. In an exemplary embodiment of the present disclosure, as shown in FIG. 6, the directional diffusion film 50 may include a first medium 51 and a second columnar medium 52 embedded in the first medium 51. In an exemplary embodiment of the present disclosure, the refractive index of the second columnar medium 52 is different from that of the first medium 51. As an example, the refractive index of the second columnar medium 52 is greater than the refractive index of the first medium 51. For example, when the light ray 53 is incident on second columnar medium 52 along a direction substantially parallel to the second columnar medium 52, the light ray 53 is totally reflected on the inner surface of the second columnar medium 52, so as to change the light exit angle, thereby forming light diffusion and thus maintaining a good degree of polarization of the exit light while achieving scattering.

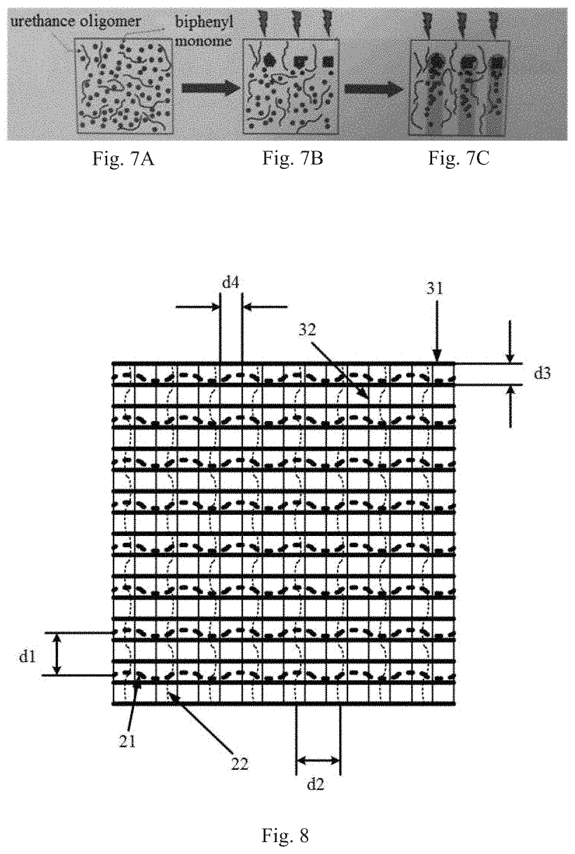

FIGS. 7A-7C are schematic diagrams of a process of forming a directional diffusion film according to an embodiment of the present disclosure. As shown in FIG. 7A, two medium with different refractive indices (for example, urethance oligomer and biphenyl monomer) are mixed to form a compatible blend. As shown in FIG. 7B, ultraviolet light (UV) is used to irradiate the compatible blend. Due to the different polymerization rates of the above two substances under UV light irradiation, when patterned UV irradiation is performed on the compatible blend, as shown in FIG. 7C, the urethance oligomers that are less sensitive to UV light are gathered in a region where the UV light does not pass through to form the first medium 51, and the biphenyl monomers that are more sensitive to UV light are gathered in a region where the UV light passes through to form the second columnar medium 52, thereby forming the directional diffusion film.

In an embodiment of the present disclosure, a degree of polarization of the polarization maintaining diffusion sheet 8′ is greater than or equal to 95%, so that the incident light can be scattered without affecting the polarization state of the incident light, so as to eliminate moire fringes.

Further, FIG. 8 is a schematic plan view of wirings in the first liquid crystal cell and the second liquid crystal cell according to an embodiment of the present disclosure. In an embodiment of the present disclosure, as shown in FIG. 8, the first liquid crystal cell 2 may include a first wiring 21 and a second wiring 22 intersecting the first wiring 21. The second liquid crystal cell 3 includes a third wiring 31 and a fourth wiring 32 intersecting the third wiring 31. Any one of the first wiring 21 and the second wiring 22 is not parallel to any one of the third wiring 31 and the fourth wiring 32. With this configuration, the effect of eliminating moire fringes can be further enhanced.

In an embodiment of the present disclosure, a shape of the first wiring 21 and the second wiring 22 may be of a curved shape, and a shape of the third wiring 31 and the fourth wiring 32 may be of a linear shape, which should not be considered as a limit to the present disclosure.

In an exemplary embodiment of the present disclosure, the curved shape may include, for example, a wave shape (as shown by the first wiring 21 and the second wiring 22 in FIG. 8).

In an embodiment of the present disclosure, as shown in FIGS. 2, 4, and 5, the display device 20 further includes a backlight resource 1 located on a side of the first liquid crystal cell 2 away from the second liquid crystal cell 3. In an embodiment of the present disclosure, the first liquid crystal cell 2 is located on a light incident side.

In an embodiment of the present disclosure, a distance between adjacent first wirings or between adjacent second wirings is greater than or equal to a distance between adjacent third wirings or between adjacent fourth wirings.

Specifically, for example, as shown in FIG. 8, a distance dl between adjacent first wirings 21 or a distance d2 between adjacent second wirings 22 is greater than or equal to a distance d3 between adjacent third wirings 31 or a distance d4 between the adjacent fourth wirings 32. More specifically, for example, the distance d1 between adjacent first wirings 21 is larger than the distance d3 between adjacent third wirings 31, and the distance d2 between adjacent second wirings 22 is larger than the distance d4 between adjacent fourth wirings 32.

In an embodiment of the present disclosure, one of the first wiring 21 and the second wiring 22 may be a data line, and the other of the first wiring 21 and the second wiring 22 may be a scan line. One of the third wiring 31 and the fourth wiring 32 may be a data line, and the other of the third wiring 31 and the fourth wiring 32 may be a scan line.

In an embodiment of the present disclosure, a direction of a transmission axis of the first polarizer 4 is parallel to a direction of a transmission axis of the second polarizer 7.

In an embodiment of the present disclosure, a direction of a transmission axis of the third polarizer 5 is perpendicular to a direction of a transmission axis of the first polarizer 4 and a direction of a transmission axis of the second polarizer 7.

In an embodiment of the present disclosure, the first liquid crystal cell 2 is configured to perform dynamic region modulation on the incident light from the backlight source 1, and the second liquid crystal cell 3 is configured to implement a display function.

The foregoing description of the embodiment has been provided for purpose of illustration and description. It is not intended to be exhaustive or to limit the application. Even if not specifically shown or described, individual elements or features of a particular embodiment are generally not limited to that particular embodiment, are interchangeable when under a suitable condition, can be used in a selected embodiment and may also be varied in many ways. Such variations are not to be regarded as a departure from the application, and all such modifications are included within the scope of the application.

1. A display device comprising:
a first liquid crystal cell and a second liquid crystal cell disposed opposite to each other;
a first polarizer located on a side of the first liquid crystal cell away from the second liquid crystal cell;
a second polarizer located on a side of the second liquid crystal cell away from the first liquid crystal cell; and
a third polarizer located between the first liquid crystal cell and the second liquid crystal cell,
wherein the display device further comprises a polarization maintaining diffusion sheet located between the first liquid crystal cell and the second liquid crystal cell.

2. The display device according to claim 1, wherein the polarization maintaining diffusion sheet is located between the third polarizer and the second liquid crystal cell or located between the first liquid crystal cell and the third polarizer.

3. The display device according to claim 1 further comprising a fourth polarizer located between the first liquid crystal cell and the second liquid crystal cell, and wherein a direction of a transmission axis of the fourth polarizer is the same as a direction of a transmission axis of the third polarizer.

4. The display device according to claim 3, wherein the polarization maintaining diffusion sheet is located between the third polarizer and the fourth polarizer.

5. The display device according to claim 1, wherein the polarization maintaining diffusion sheet comprises a directional diffusion film.

6. The display device according to claim 5, wherein the directional diffusion film comprises a first medium and a second columnar medium embedded in the first medium, and wherein the refractive index of the second columnar medium is different from that of the first medium.

7. The display device according to claim 1, wherein a degree of polarization of the polarization maintaining diffusion sheet is greater than or equal to 95%.

8. The display device according to claim 1, wherein the first liquid crystal cell comprises a first wiring and a second wiring intersecting the first wiring, wherein the second liquid crystal cell comprises a third wiring and a fourth wiring intersecting the third wiring, and wherein any one of the first wiring and the second wiring is not parallel to any one of the third wiring and the fourth wiring.

9. The display device according to claim 8, wherein a shape of the first wiring and the second wiring is of a curved shape, and wherein a shape of the third wiring and the fourth wiring is of a linear shape.

10. The display device according to claim 8, wherein the first liquid crystal cell is located on a light incident side, and wherein a distance between the adjacent first wirings or between the adjacent second wirings is greater than or equal to a distance between the adjacent third wirings or between the adjacent fourth wirings.

11. The display device according to claim 8, wherein one of the first wiring and the second wiring is a data line, wherein the other of the first wiring and the second wiring is a scan line, wherein one of the third wiring and the fourth wiring is a data line, and wherein the other of the third wiring and the fourth wiring is a scan line.

12. The display device according to claim 1, wherein a direction of a transmission axis of the first polarizer is parallel to a direction of a transmission axis of the second polarizer.

13. The display device according to claim 1, wherein a direction of a transmission axis of the third polarizer is perpendicular to a direction of a transmission axis of the first polarizer and a direction of a transmission axis of the second polarizer.

14. The display device according to claim 1, further comprising a backlight source located on a side of the first liquid crystal cell away from the second liquid crystal cell.

15. The display device according to claim 14, wherein the first liquid crystal cell is configured to perform dynamic region modulation on incident light from the backlight source, and wherein the second liquid crystal cell is configured to implement a display function.
